(19) United States
(12) Patent Application Publication
(10) Pub. No.: US 2007/0224589 A1
(43) Pub. Date: Sep. 27, 2007

(54) Protection of Biologically Active Molecules Using Amphiphiles

(75) Inventor: Marcel Herman Jozef Ruiters, Groningen (NL)

Correspondence Address: PEACOCK MYERS, P.C., 201 THIRD STREET, N.W., SUITE 1340, ALBUQUERQUE, NM, 87102, US

(73) Assignee: Synvolux IP B.V., Groningen (NL)

(21) Appl. No.: 11/737,588

(22) Filed: Apr. 19, 2007

Related U.S. Application Data
(63) Continuation-in-part of application No. PCT/NL05/00752, filed on Oct. 20, 2005.

(30) Foreign Application Priority Data
Oct. 21, 2004 (NL) 1027311
Nov. 4, 2004 (NL) 1027417
Nov. 10, 2004 (NL) 1027479

(51) Int. Cl. A01N 1/02

(52) U.S. Cl. 435/2

(57) ABSTRACT

A process for the protection of a biologically active compound against the effect of for instance enzymes, chemicals, oxygen, radicals or sunlight. The process is characterized in comprising the step of bringing the biologically active compound in contact with at least one SAINT-molecule. Thereby a good protection from the biologically active compound is achieved.

### CROSS-REFERENCE TO RELATED APPLICATIONS

This application is a continuation-in-part application of Patent Cooperation Treaty (PCT) Serial No. PCT/NL2005/000752, entitled “Protection of Biologically Active Molecules Using Amphiphiles”, to Synvolux IP B.V., filed on Oct. 20, 2005, and the specification and claims thereof are incorporated herein by reference.

This application claims priority to and the benefit of the filing of Netherlands Patent Application Serial No. 1027311, entitled “Vehicle to Transport a DNA-Modifying Enzyme to a Genome”, to Synvolux IP B.V., filed on Oct. 21, 2004, and the specification and claims thereof are incorporated herein by reference.

This application claims priority to and the benefit of the filing of Netherlands Patent Application Serial No. 1027417, entitled “Vehicle for the Transport of a Chosen Molecule to a Cell”, to Synvolux IP B.V., filed on Nov. 4, 2004, and the specification and claims thereof are incorporated herein by reference.

This application claims priority to and the benefit of the filing of Netherlands Patent Application Serial No. 1027479, entitled “Protection of Biologically Active Molecules Using Amphiphiles”, to Synvolux IP B.V., filed on Nov. 10, 2004, and the specification and claims thereof are incorporated herein by reference.

### BACKGROUND OF THE INVENTION

1. Field of the Invention:

The present invention relates to a process to protect a biologically active compound against the effects of for instance enzymes, chemicals, oxygen, radicals or sunlight. Further the invention relates to a vehicle to protect a biological active compound against the effects of for instance enzymes, chemicals, oxygen, radicals or sunlight. The invention also relates to the application of a SAINT-molecule to protect a biological active compound against the effects of for instance enzymes, chemicals, oxygen, radicals or sunlight.

2. Description of Related Art

In general, biologically active compounds, such as siRNA, RNA, DNA, proteins and peptides are sensitive for the effects (e.g. degradation) of for instance enzymes, chemicals, oxygen, radicals or sunlight. For example, in many cases biologically active compounds, such as siRNA, RNA, DNA, oligonucleotides or derivates thereof, proteins and peptides can only be transported as dry matter, or as a stabilized, glycerol or DMSO containing solution. The solutions to be transported or dry matters are kept on dry ice, or are cooled in another way. Consequently, the transportation of these compounds is very expensive.

Another disadvantage of transporting biologically active compounds as dry matter is the fact that during the dissolution of the biologically active compound a conformational change may occur. As a result, not all biologically active matter will regain its original function.

Also the transport of the biologically active compound in a (buffered) glycerol (or DMSO) containing solution has disadvantages. Glycerol (or DMSO) has shown to have a negative effect on the activity of the biologically active compound when the biologically active compound is diluted before application.

The solution found in the state of the art to circumvent these disadvantages is to replace the glycerol (or DMSO) by threhalose. Threhalose is a sugar. Although in theory no conformational change occurs when dissolving the biologically active compound in threhalose, there are some other disadvantages when using threhalose. A particular disadvantage is that threhalose has an adverse effect on the desired enzymatic activity of the proteins. In the state of the art threhalose is not used to package DNA, RNA, siRNA en oligonucleotides or derivatives thereof. After complexation with threhalose (and other sugars) DNA, RNA etc, are laboriously to be dissolved, as they can also be characterized as sugars.

### BRIEF SUMMARY OF THE INVENTION

The present invention aims at solving the disadvantages mentioned above.

In particular, the invention aims to provide for a process to protect a biologically active compound against the effects of for instance enzymes, chemicals, oxygen, radicals or sunlight. The invention also aims to provide for a vehicle to protect a biologically active compound against the effects of enzymes, chemicals, oxygen, radicals or sunlight whereby the disadvantages mentioned above can be circumvented.

The word “transport” is understood to mean both the packaging of the biologically active compound in a transportation container, and the subsequent conveyance of this container by means of transportation means, such as carriers, etc., as well as the transport of individual biologically active molecules, which are each separately enwrapped by the protecting compounds.

### STATEMENT REGARDING REDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 shows remaining enzyme activity after transfection of 1 μg siRNA with SAINT-RED.

FIG. 2 shows, over a 9 month-period, the siRNA stored at −20° C. degrees versus the siRNA/SAINT-RED preservation complex. Enzyme activity was measured 48 hours after transfection.

### DETAILED DESCRIPTION OF THE INVENTION

To meet at least one of the aforementioned aims, the present invention provides for a process as mentioned in the preamble, which process is characterized by the measures according to claim 1. Herewith the advantage is reached that the biologically active compound has become completely protected from effects of enzymes, chemicals, oxygen, radicals or sunlight.

Furthermore, completely no or no functional inhibitory conformational changes of the biological compound occur.

Furthermore the invention provides for a vehicle as mentioned in the pre-amble. The vehicle of the present invention provides a very reliable and simple solution for transporting a biologically active compound in such a way that the biologically active compound will not become damaged, for instance by the effect of enzymes, chemicals, oxygen, radicals or sunlight, or a conformational change occurs.

According to a further aspect of the invention an application is provided in which a SAINT-molecule protects a biologically active compound against the effect of for instance enzymes, chemicals, oxygen, radicals or sunlight, which is characterized in that the biologically active compound is contacted with the biologically active compound, causing the biologically active compounds to interact with the SAINT-molecule.

By means of the invention, the biologically active compound, which can be chosen from, for instance, siRNA, RNA, DNA, oligonucleotides or derivatives thereof, proteins and peptides, is actually enwrapped by one ore more SAINT-molecules. The saint molecules may all be of the same kind, but it is also possible that a mixture of different SAINT-molecules is applied, which can be connected to the biological active compound. This interaction is a hydrogen-bond.

It has been shown that the vehicle of the present invention, consisting of the biologically active compound and the SAINT-molecule or SAINT-molecules enwrapping it, can be kept without incurring a separation of the biologically active compound and the SAINT molecules. Nevertheless, it has also been shown that, when the biologically active compound has to fulfill its function, it is not suffering any functional hindrance from the SAINT-molecules present. Therefore the biologically active compounds can freely operate and can easily be applied in basically any biological assay. A remarkably great advantage of the present invention is that no separation of the SAINT-molecule(s) from the biological active compound is needed, because the Saint-molecule(s) have no inhibitory effect in the buffer. The molecule will be diluted to such a great extent, that no inhibitory effect will be shown. Furthermore it is biologically degradable, without forming any toxic compounds.

The invention has been described in essence in the above. Based on the description above and the attached claims, a person skilled in the art will easily be able to develop further embodiments, which all will fall within the scope of the present invention.

### EXAMPLE

One of the most sensitive and at this moment frequently used biologically active compounds is siRNA. SiRNA, when directed to a specific gene, is able to silence the gene-expression by inhibition of the mRNA translation.

SIRNA needs to be stored as dried powder and, after dissolution, aliquots are stored at −20° C. Regardless of aliquots being prepared, the reproducibility of (the results obtained over time using) such aliquots is weak. The delivery of siRNA to cells has been described in patents EP-0755924 and U.S. Pat. No. 5,853,694.

To illustrate the present invention we here show data concerning the preservation of siRNA by the use of SAINT-molecules.

Method:

25 micrograms of siRNA were complexed with 0.5 ml of SAINT-MIX. Per transfection 20 μl of this (preservation)-complex is used. Transfection was performed as described in detail in EP-0755924.

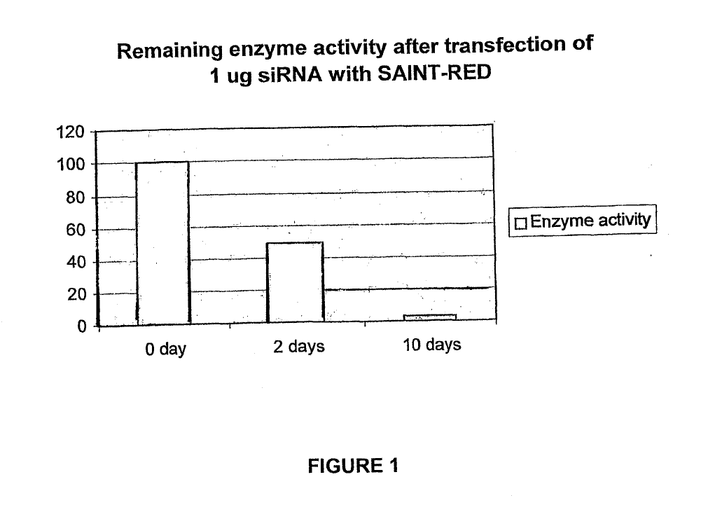

The efficacy of the siRNA-transfection is validated by measuring the enzyme activity of the silenced gene according to a standard enzyme assay. Lifetime of the enzyme is approximately 5 days. Therefore, after one single transfection with 1 ug siRNA, about 50% enzyme activity can be measured after 48 hours and almost no enzyme activity can be measured after 10 days, as shown in FIG. 1.

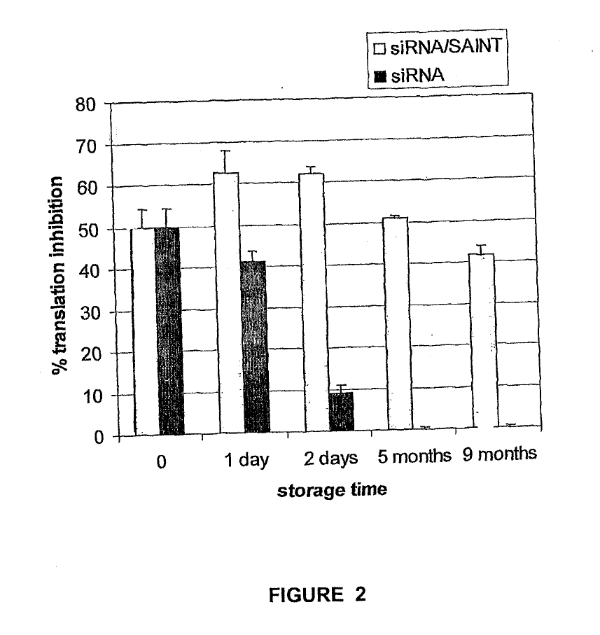

FIG. 2 shows, over a 9 month-period, the siRNA stored at −20° C. degrees versus the siRNA/SAINT-RED preservation complex. Enzyme activity was measured 48 hours after transfection.

The figure clearly shows that siRNA complexed with SAINT-RED is active over a 9 month-period while the aliquoted siRNA has lost almost all its activity within 2 days. Moreover the results show that the siRNA/SAINT prevention complex is even more active, up to 5 months, when compared with the freshly prepared siRNA/SAINT complex.

This indicates the strong protective character of SAINT-molecules towards biologically active compounds.

What is claimed is:

1. A process for the protection of a biologically active compound comprising the steps of providing a biologically active compound and bringing the biologically active compound in contact with a SAINT-molecule.

2. The process according to claim 1, wherein the bringing this step comprises contacting of a biologically active compound with a mixture of SAINT-molecules.

3. The process according to claim 1, wherein the biologically active compound is bound to at least one SAINT-molecule by means of electrostatic interaction.

4. The process according to claim 1, wherein the process protects the biologically active compound against effects of one or more of the group consisting of enzymes, chemicals, oxygen, radicals, and sunlight.

5. A process to preserve a biologically active compound comprising the steps of providing a biologically active compound and combining the biologically active compound with a SAINT-molecule or a mixture thereof.

6. The process of application of a SAINT-molecule for the protection of a biologically active compound wherein the biologically active compound is brought in contact with a SAINT-molecule in such a way that the biologically active compound interacts with the SAINT-molecule through electrostatic interaction.

7. The process according to claim 6, wherein the process protects the biologically active compound against effects of one or more of the group consisting of enzymes, chemicals, oxygen, radicals, and sunlight.
